(19) United States
(12) Patent Application Publication
(10) Pub. No.: US 2006/0037292 A1
(43) Pub. Date: Feb. 23, 2006

(54) Device having a function of adsorbing airborne molecular contamination

(76) Inventor: Tsu-Lung Fu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,315

(22) Filed: Aug. 16, 2005

(30) Foreign Application Priority Data
Aug. 17, 2004 (TW) 93213090

(51) Int. Cl. B01D 50/00

(52) U.S. Cl. 55/385.1

(57) ABSTRACT

A device having a function of adsorbing airborne molecular contamination (AMC), such as a photomask box, a wafer box used in integrated circuit manufacturing, or an LCD panel box used in LCD manufacturing, is characterized in that an adsorbing AMC unit is located in the box for adsorbing airborne molecular contamination to prevent the airborne molecular contamination from reacting with the mask or wafer to affect the mask pattern distribution or yield of devices formed on the wafer or LCD panel. The adsorbing AMC unit packaged with adsorbing material is located in the box body.

### RELATED APPLICATIONS

The present application is based on, and claims priority from, Taiwan Application Serial Number 93213090, filed on Aug. 17, 2004, the disclosure of which is hereby incorporated by reference herein in its entirety.

### FIELD OF THE INVENTION

This present invention relates to a device having a function of adsorbing gas, and particularly, to a photomask box or a wafer box having a function of adsorbing airborne molecular contamination (AMC) such as organic or inorganic gas.

### BACKGROUND OF THE INVENTION

As semiconductor processing technology has progressed, requirements of environments from wafer factories have also increased. When a stage of a semiconductor process is finished and another stage of the process starts, a wafer must be taken out from one reaction chamber and sent to the subsequent reaction chamber of the process. In most modern wafer factories, to prevent the wafer from being polluted by an environment during transition of the wafer, the wafer is sent through a wafer box. For a product line of a current 8-inch or 12-inch wafer factory, a standard mechanical interface (SMIF) system is mainly utilized to transmit the wafer. The above SMIF system has a standardized process for designing, conveying and transporting the wafer box.

In addition, during making an integrated circuit (IC), many lithograph processes are utilized to form patterns with a submicron or nanometer dimension to make memory modules with ultrahigh density of integration. During a lithograph process, an exposure machine (such as a scanner) automatically takes out a photomask, which is placed in a photomask box, and then aligns and exposes. Lithograph processes of different products and different layers need different photomasks. During replacing the photomask, the photomask is first moved from the machine to the photomask box, and then the photomask box with the photomask is taken out and transported.

It is known from the above description that process technology of ICs has entered a high density submicron or nanometer stage. Therefore, when a photomask which has particles thereon or has a damaged pattern thereon is utilized for a lithograph process, a pattern formed on a surface of a wafer is distorted, which results in reduction of yield and possibly total loss of processed IC modules. In accordance with the practice of wafer factories, several reasons that adversely affect the pattern of the photomask mainly include particles, crystallization deposits, scratches and electrostatic damage. Therefore, most of photomasks are stored in the photomask box for protection when not in use. Similarly, most of wafers which are being made are placed in the wafer box for protection when pending. However, a micro-quantity of polluted gas of the clean room may react with the surface of the photomask and wafer, which adversely affects the photomask and wafer pattern distribution and so results in yield lost of the wafer.

Accordingly, it is required to provide an improved device to avoid AMC adversely affecting pattern distribution of a photomask placed in a photomask box or IC module on a wafer placed in a wafer box.

### SUMMARY OF THE INVENTION

An object of the present invention is to provide a device having a function of adsorbing AMC.

Another object of the present invention is to provide a photomask box having a function of adsorbing AMC, such as organic or inorganic gas.

Another object of the present invention is to provide a wafer box having a function of adsorbing AMC, such as organic or inorganic gas.

To achieve the above objects, the present invention provides a device having a function of adsorbing gas. The device is a container for carrying a photomask transportation box, a photomask box, a photomask storage tank, a wafer box or an LCD panel box, characterized in that an adsorbing gas unit is located in the container for adsorbing airborne molecular contamination in the container. The adsorbing gas unit packaged with adsorbing material is located in the container.

A device having a function of adsorbing gas, such as a photomask box, a wafer box used in integrated circuit manufacturing or a photomask box, an LCD panel box used in LCD manufacturing, is characterized in that an adsorbing gas unit is located in the box for adsorbing airborne molecular contamination to prevent the airborne molecular contamination from reacting with the mask or wafer to affect the mask pattern distribution or yield of devices formed on the wafer or LCD panel. The adsorbing gas unit packaged with adsorbing material is located in the box body.

A device having a function of adsorbing AMC, such as a photomask box, includes a lower cover which has a photomask housing for carrying a photomask through a supporting bracket to support the photomask; an upper cover which is coupled to the lower cover to form a box body thereby protecting the photomask therein; and an adsorbing AMC unit for adsorbing AMC, such as organic or inorganic gas for preventing the gas from reacting with the photomask to adversely affect the mask pattern distribution. The adsorbing gas unit packaged with adsorbing material is located in the box body.

A device having a function of adsorbing AMC, such as a wafer box, includes a boat which is defined with a plurality of slots; a casing carrying the boat; and an adsorbing AMC unit for adsorbing AMC, such as organic or inorganic gas for preventing the gas from reacting with the wafer received in the slot to adversely affect yield of the IC module formed on the wafer. The adsorbing AMC unit packaged with adsorbing material is located in the casing.

These and other embodiments, aspects and features of the invention will be better understood from a detailed description of the preferred embodiments of the invention, which are further described below in conjunction with the accompanying figures.

### BRIEF DESCRIPTION OF THE DRAWINGS

FIG. 1 is a schematic view of a photomask box having a function of adsorbing AMC of the present invention.

FIG. 2 is a schematic view of a wafer box having a function of adsorbing AMC of the present invention.

FIGS. 3a and 3b are schematic views of a container and a spacer of the present invention, the container having a function of adsorbing AMC for carrying a photomask box or a wafer box.

### DETAILED DESCRIPTION OF THE PREFERRED EMBODIMENT

The present invention provides a device having a function of adsorbing AMC such as organic or inorganic gas, such as a photomask box or a wafer box, which is detailedly described hereinafter in connection with the preferred embodiments and the accompanying figures thereof. It is appreciated that the preferred embodiments of the present invention are only for the purpose of illustration. Therefore, besides the preferred embodiments, the present invention may be widely applied to, for example, a photomask transportation box, a photomask storage tank, an LCD panel box and so on, but not limited to a photomask box or a wafer box. The present invention is not limited to any embodiment.

The present invention provides a device having a function of adsorbing AMC. The device is a container for carrying a photomask transportation box, a photomask box, a photomask storage tank, a wafer box or an LCD panel box, characterized in that an adsorbing AMC unit is located in the container for adsorbing AMC in the container. The adsorbing AMC unit packaged with adsorbing material is located in the container.

A device having a function of adsorbing AMC, such as a photomask box, a wafer box used in integrated circuit manufacturing, or an LCD panel box used in LCD manufacturing, is characterized in that an adsorbing AMC unit is located in the box for adsorbing airborne molecular contamination to prevent the airborne molecular contamination from reacting with the mask or wafer to affect the mask pattern distribution or yield of devices formed on the wafer or LCD panel. The adsorbing AMC unit packaged with adsorbing material is located in the box body.

A photomask box having a function of adsorbing AMC, such as organic or inorganic gas, includes a lower cover which has a photomask housing for carrying a photomask through a supporting bracket to support the photomask; an upper cover which is coupled to the lower cover to form a box body thereby protecting the photomask therein; and an adsorbing AMC unit for adsorbing AMC, such as organic or inorganic gas for preventing the AMC from reacting with the photomask to adversely affect the mask pattern distribution. The adsorbing AMC unit packaged with adsorbing material is located in the box body and does not adversely affect the storage or replacement of the photomask.

A wafer box having a function of adsorbing AMC, such as organic or inorganic gas includes a boat which is defined with a plurality of slots; a casing carrying the boat; and an adsorbing AMC unit for adsorbing AMC, such as organic or inorganic gas, for preventing the gas from reacting with the wafer in the slot to adversely affect yield of the IC modules formed on the wafer. The adsorbing AMC unit packaged with adsorbing material is located in the casing.

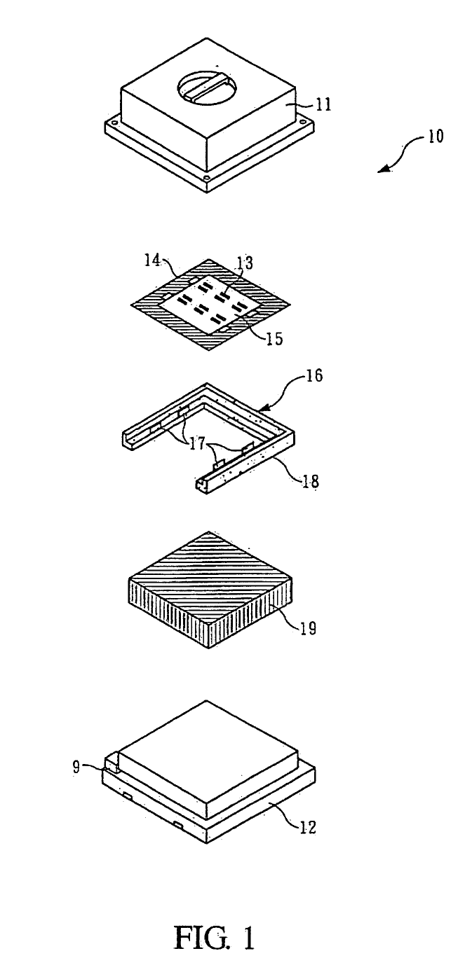

FIG. 1 is a schematic view of a photomask box having a function of adsorbing AMC of the present invention.

Referring to FIG. 1, a photomask box 10 is a box-shaped structure formed by an upper cover 11 and a lower cover 12. A photomask housing 19 is disposed above the lower cover 12 and may utilize a support bracket 18 to support a photomask 14, which is for making an IC, and to protect the photomask 14 in the photomask box 10 for preventing the photomask 14 from being damaged or polluted by the environment after the upper and lower covers 11, 12 mate with each other. The photomask 14 includes an exposure zone 15 and a non-exposure zone 13. For example, the photomask 14 is formed on the basis of a glass which is made of transparent quartz material and is coated with a chromium layer on the non-exposure zone 13 for forming patterns of the photomask 14.

The support bracket 18 of the photomask housing 19 includes four support posts 17 and three side flanges 16. The three side flanges 16 are respectively disposed at opposite sides and a rear side of the photomask housing 19. The four support posts 17 are respectively disposed at the inner sides of the side flanges 16 at the opposite sides of the photomask housing 19. Thus, the support bracket 18 can support the four corners of the photomask 14 and surround opposite sides and a rear side of the photomask 14 therein. It is understood that the number of the support posts 17 and the side flanges 16 may be varied according to demands. Additionally, in order to enable the side flanges 16 of the support bracket 18 to produce shielding effect to the carried photomask 14 for preventing the pattern distribution of the photomask 14 from being damaged by environmental static charges, the side flanges 16 are made from a material which must have free electrons, such as metal or nonmetal dissipative material. However, since metal material may generate sparks due to action of static charges, which may damage the pattern distribution on the surface of the photomask 14, the side flanges 16 of the support bracket 18 are preferably made from nonmetal dissipative material.

Since IC process technology has entered a high density submicron or nanometer stage, when the photomask 14 that has particles thereon or has a damaged pattern thereon is utilized for a lithograph process, a pattern formed on a surface of a wafer is distorted, which results in reduction of yield and even complete loss of IC modules. In accordance with the practice of wafer factories, the reasons that adversely affect the pattern of the photomask 14 mainly include particles, crystallization deposits, scratches, and electrostatic damage. Environmental airborne molecular contamination may form a haze on the surface of the photomask and so adversely affect the pattern of the photomask. Scratches are caused mostly by external force acting on the chromium layer of the surface of the photomask 14. Static may result in damage of the pattern of the photomask 14. The static is mainly caused by friction produced by gas from the clean room, and work clothes or robot arms during transportation. Since the static may generate a voltage equivalent to 700V, the chromium layer of the photomask 14 may be damaged by the static, which adversely affects the pattern distribution. Therefore, most of photomasks 14 are stored in the photomask box 10 for protection when not in use.

It is known from the above description that the photomask 14 may be placed in the photomask box 10 for a long time. To prevent the AMC from reacting with the chromium layer of the photomask 14 placed in the photomask box 10 to adversely affect the integrality of the pattern of the photomask 14, the present invention provides a containing adsorbing AMC material unit 9 disposed in the photomask box 10. The unit 9 packages adsorbing material therein and is disposed in the photomask box 10. The containing adsorbing AMC material unit 9 is able to adsorb AMC, such as organic or inorganic gas, inside or around the photomask box 10 for completely preventing the AMC inside or around the photomask box 10 from reacting with the chromium layer of the photomask 14 placed in the photomask box 10. For example, the adsorbing material includes silicon gel, molecular sieve, zeolite, activated carbon or the related derivatives thereof. Chemical composition of the molecular sieve is crystalline alumino-silicates. Particular monodisperse and porous microstructure may be formed through a special chemosynthesis mechanism. The monodisperse and porous microstructure does not expand or dissolve after adsorbing gas but keeps dry. The dimension of the disperse of the microstructure is similar to the dimension of the gas molecule.

A method of packaging the adsorbing material, for example, is to utilize ventilative material or metal to package or to make the adsorbing material into a sheet adsorber.

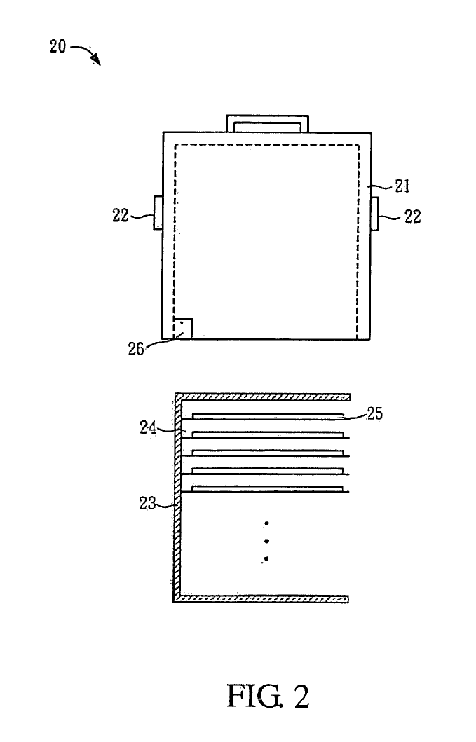

FIG. 2 is a schematic view of a wafer box having a function of adsorbing AMC of the present invention.

Referring to FIG. 2, a wafer box 20 includes a boat 23 and a casing 21. The boat 23 is defined with a plurality of slots 24 therein. For example, the number of the slots 24 is 25. Each slot 24 is able to receive a piece of wafer 25. That is, each boat 23 can carry 25 disks of wafers 25. The casing 21 is an openable and closeable cover which is able to carry the boat 23. The wafer box 20 further includes a rotatable pin (not shown) which is disposed at the casing 21 for controlling opening or closing the casing 21 thereby taking out the boat 23 from the casing 21 or placing the boat 23 inside the casing 21. The rotatable pin is important to the connection between the casing 21 and the boat 23. When the rotatable pin is rotated to a fault position, the wafer 25 in the slot 24 may be damaged.

In addition, a pair of handles 22 is disposed at opposite sides of the casing 21 for facilitating to carry and transport the wafer box 20.

In addition, with regard to the IC process technology, that the pending wafer 25 has particles on the surface thereof results in reduction of yield and even complete loss of IC modules. In accordance with the practice of wafer factories, the particles and scratches really adversely affect yield and performance of the IC modules on the wafer 25. The particles mainly come from environmental air. The scratches are caused mostly by an external force acting on the surface of the wafer 25. Therefore, most of wafers 25 which are being made are placed in the wafer box 20 for protection when pending.

It is known from the above description that the wafer 25 may be placed in the wafer box 20 for a long time. To prevent the environmental AMC from reacting with the IC modules of the wafer 25 placed in the wafer box 25 and adversely affecting the yield and performance of the IC modules, the present invention provides a containing adsorbing AMC material unit 26 disposed inside the wafer box 20. The unit 26 packages adsorbing material therein and is disposed in the wafer box 20. The containing adsorbing AMC material unit (adsorbing gas unit) 26 is able to adsorb AMC, such as organic or inorganic gas, inside or around the wafer box 20 for completely preventing the AMC inside or around the wafer box 20 from reacting with the IC module of the wafer 25 placed in the wafer box 20. For example, the adsorbing material includes silicon gel, molecular sieve, zeolite, activated carbon or the related derivatives thereof. Chemical composition of the molecular sieve is crystalline alumino-silicates. Particular monodisperse and porous microstructure may be formed through a special chemosynthesis mechanism. The monodisperse and porous microstructure does not expand or dissolve after adsorbing gas but keeps dry. The dimension of the disperse of the microstructure is similar to the dimension of the gas molecule.

A method of packaging the adsorbing material, for example, is to utilize ventilative material or metal to package or to make the adsorbing material into a sheet adsorber.

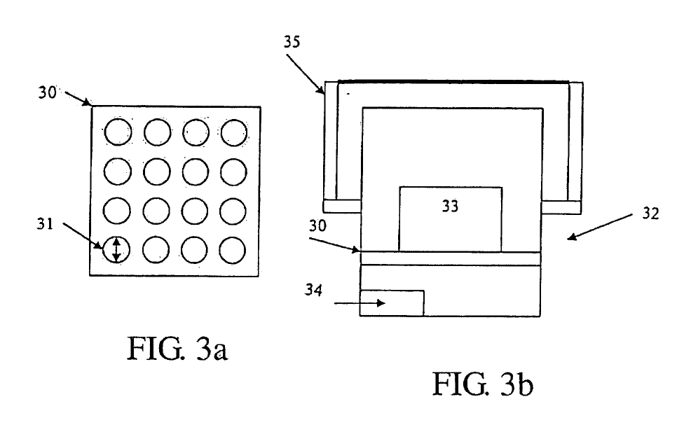

FIGS. 3a and 3b are schematic views of a container and a spacer of the present invention, the container having a function of adsorbing AMC for carrying a photomask box or a wafer box.

Referring to FIGS. 3a and 3b, a container 32 includes a spacer 30 disposed therein. The container 32 is able to carry, for example, a photomask transportation box, a photomask box, a photomask storage tank, a wafer box, or a panel box for IC process. For example, the container 32 is used to carry a photomask box 33. In addition, the spacer 30 is defined with a plurality of openings 31. For example, each opening 31 is a hole.

In addition, a pair of handles 35 is disposed at opposite sides of the container 32 for facilitating to carry and transport the container 32.

In practice, the photomask box 33 may be placed in the container 32 for a long time. To prevent the environmental AMC from reacting with the photomask inside the photomask box 33 placed in the container 32 and adversely affecting the yield and performance of the IC modules, the present invention provides a containing adsorbing AMC material unit 34 disposed inside the container 32. The unit 34 packages adsorbing material therein and is disposed in the container 32. The containing adsorbing AMC material unit (adsorbing AMC unit) 34 is able to adsorb AMC, such as organic or inorganic gas, inside or around the container 32 for completely preventing the AMC inside or around the container 32 from reacting with the photomask inside the photomask box 33 placed in the container 32. For example, the adsorbing material includes silicon gel, molecular sieve, zeolite, activated carbon or the related derivatives thereof. Chemical composition of the molecular sieve is crystalline alumino-silicates. Particular monodisperse and porous microstructure may be formed through a special chemosynthesis mechanism. The monodisperse and porous microstructure does not expand or dissolve after adsorbing gas but keeps dry. The dimension of the disperse of the microstructure is similar to the dimension of the gas molecule.

A method of packaging the adsorbing material, for example, is to utilize gas-permeable material or metal to package or to make the adsorbing material into a sheet adsorber.

The present invention has the following advantages:

1. The package of the adsorbing material of the present invention is simple and easy to handle.

2. The adsorbing AMC unit of the present invention can increase the usage lifetime of the photomask and reduce and slow down the crystallization deposits of the photomask.

3. The adsorbing AMC unit of the present invention can avoid reducing yield loss of the IC modules.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. A device having a function of adsorbing airborne molecular contamination (AMC), used as a container for carrying a photomask transportation box, a photomask box, a photomask storage tank, a wafer box or an LCD panel box, said device comprising:
an adsorbing AMC unit located in said container for adsorbing AMC in said container, wherein adsorbing material is packaged in said adsorbing AMC unit for adsorbing said AMC.

2. The device of claim 1, wherein said AMC is selected from the group consisting of organic gas, inorganic gas and the mixtures thereof.

3. The device of claim 1, wherein said adsorbing material is selected from the group consisting of silicon gel, molecular sieve, zeolite, activated carbon, the mixtures thereof and the related derivatives thereof.

4. The device of claim 1, wherein said adsorbing AMC unit comprises a package body using gas-permeable material.

5. The device of claim 1, wherein said adsorbing AMC unit comprises a package body using metal wrapping.

6. The device of claim 1, wherein said adsorbing material is formed into a sheet adsorber, and is placed inside said container.

7. A device having a function of adsorbing AMC, used as a container for carrying a photomask, a wafer or a LCD panel for manufacturing an electronic product, said device comprising:
an adsorbing AMC unit located in said container for adsorbing AMC particles in said container so as to prevent said photomask, said wafer or said LCD (Liquid Crystal Display) panel from reacting with crystallization deposits effecting the pattern distribution of said photomask or yield of the devices formed on said wafer or said LCD panel, wherein adsorbing material is packaged in said adsorbing AMC unit for adsorbing said AMC.

8. The device of claim 7, wherein said container is a photomask transportation box, a photomask box, a photomask storage tank, a wafer box or an LCD panel box.

9. The device of claim 7, wherein said AMC are selected from the group consisting of organic gas, inorganic gas and the mixtures thereof.

10. The device of claim 7, wherein said adsorbing material is selected from the group consisting of silicon gel, molecular sieve, zeolite, activated carbon, the mixtures thereof and the related derivatives thereof.

11. The device of claim 7, wherein said adsorbing gas unit comprises a package body using gas-permeable material.

12. The device of claim 7, wherein said adsorbing AMC unit comprises a package body using metal wrapping.

13. The device of claim 7, wherein said adsorbing material is formed into a sheet adsorber, and is placed inside said container.

14. The device of claim 7, wherein said container is a photomask box, said photomask box comprising:
a lower cover having a photomask base used for carrying said photomask via a supporting bracket to support said photomask;
an upper cover coupled to said lower cover to form a box body, thereby protecting said photomask residing in said box body; and
said adsorbing AMC unit disposed in said box body for adsorbing said AMC so as to prevent said photomask from reacting with said AMC adversely effecting the pattern distribution of said photomask.

15. The device of claim 14, wherein said supporting bracket includes three side flanges respectively disposed at two opposite sides and a rear side of said photomask base.

16. The device of claim 7, wherein said container is a wafer box, said wafer box comprising:
a boat having a plurality of slots defined therein;
a casing carrying said boat; and
said adsorbing AMC unit disposed in said wafer box for adsorbing AMC so as to preventing said wafer received into said slots from reacting with said AMC adversely affecting yield of the devices formed on said wafer.

17. The device of claim 16, wherein said casing is an openable and closeable cover.

18. The device of claim 16, wherein said wafer box further comprises:
a rotatable pin disposed at the border between the opening and closing of said casing, wherein said rotatable pin is used to open or close said casing for taking out or placing said boat from or into said casing.

19. The device of claim 16, wherein said boat having 25 slots, each of said slots receiving one wafer.

20. The device of claim 16, wherein said wafer box further comprises:
a pair of handles disposed at two opposite sides of said casing.
